(19) United States
(12) Patent Application Publication
(10) Pub. No.: US 2025/0218291 A1
(43) Pub. Date: Jul. 3, 2025

(54) METHOD AND SYSTEM FOR PRODUCING VEHICLE AWARENESS NOTIFICATIONS

(71) Applicant: Eye-Net Mobile Ltd., Ness Ziona (IL)

(72) Inventors: Dror ELBAZ, Rishon Lezion (IL); Tal LAVI, Modi’in (IL)

(73) Assignee: Eye-Net Mobile Ltd., Ness Ziona (IL)

(21) Appl. No.: 18/850,657

(22) PCT Filed: Mar. 23, 2023
(86) PCT No.: PCT/IL2023/050305

§ 371 Date: Sep. 25, 2024

Related U.S. Application Data
(60) Provisional application No. 63/323,528, filed on Mar. 25, 2022.

(51) Int. Cl. G08G 1/0967; B60W 10/04; B60W 10/18; B60W 10/20; B60W 50/14; B60W 60/00; G08G 1/052; G08G 1/16

(52) U.S. Cl. CPC G08G 1/096775; B60W 10/04; B60W 10/18; B60W 10/20; B60W 50/14; B60W 60/001; G08G 1/052; G08G 1/16; B60W 2556/45; B60W 2710/18; B60W 2710/20

(57) ABSTRACT

A method and system for producing a vulnerable vehicle awareness notification by a server device may include, on a server side: receiving, from a first client device, a location data element, representing current geographical location of the first client device; repeatedly receiving, from one or more second client devices, a corresponding position sample data element associated with a current timestamp; for at least one second client device, identifying a condition of geographical vicinity between the first client device and the at least one second client device; and based on said identified condition, sending the subset of position samples to the first client device. The first client device may, in turn, produce the vulnerable vehicle awareness notification based on the received subset of position samples.

### CROSS-REFERENCE TO RELATED APPLICATIONS

This application claims the benefit of priority of U.S. Provisional Patent Application No. 63/323,528, filed Mar. 25, 2022, which is hereby incorporated by reference in its entirety.

### FIELD OF THE INVENTION

The present invention relates generally to communication networks. More specifically, the present invention relates to using communication networks to produce vehicle awareness notifications.

### BACKGROUND OF THE INVENTION

As known to cyclists and road users, the current state of road traffic presents a perilous condition, in which two-wheeler vehicles are often threatened, or even run over by motor vehicles. Bikers are not protected or shielded as car users, and are very vulnerable to physical harm. Injuries sustained from biking accidents are typically severe, or even fatal.

Many such accidents occur because bikers surprise motor vehicle drivers, who may not be aware of having a bike in their vicinity. Therefore, a need arises to warn car drivers about the existence of vulnerable vehicles such as two-wheelers (e.g., bicycles, electric scooters, motorcycles, and the like) in their vicinity. However, as elaborated herein, currently available solutions are maladroit, consume excessive resources of data and hardware, are unreliable, and inherently produce a large number of false-positive warnings, leading to alert fatigue.

Some currently available camera-based Advanced Driver Assistance System (ADAS) solutions may depend upon, and be limited to a clear line of sight between vehicles (e.g., between motor vehicles and vulnerable vehicles such as bicycles).

### SUMMARY OF THE INVENTION

The terms “vulnerable vehicle” and “two-wheeler vehicle” may be used herein interchangeably, to indicate any mode of transportation that may be regarded as being vulnerable in a condition of collision with a motorized vehicle such as a car. For example, it may be appreciated that in a condition of a collision between a car and a two-wheeler vehicle such as a bicycle or motorcycle, the latter may be regarded as more vulnerable than the former, in a sense that a driver of the two-wheeler vehicle may be more susceptible to injury than the driver of the car.

Embodiments of the invention may include a method of producing a vehicle awareness notification by at least one processor of a client computing device.

For example, the client computing device may be included in, or associated with a first vehicle (e.g., a car). As elaborated herein, the client computing device may determine that a position of the first vehicle is following, or “closing in” on historical positions of a second, vulnerable vehicle, such as a bicycle. The client computing device may consequently provide an awareness notification to a driver of the first vehicle (e.g., car), alerting them against colliding with the second, vulnerable vehicle.

In another example, the client computing device may be included in, or associated with the second, vulnerable vehicle (e.g., bicycle). As elaborated herein, the client computing device may determine that a position of the first vehicle (e.g., the car) is following, or “closing in” on historical positions of the vulnerable vehicle, and may consequently provide an awareness notification to a driver of the vulnerable vehicle (e.g., the bicycle), to beware of the approaching car.

Embodiments of the method may include sending at least one location data element, representing current geographical location of the first client computing device to at least one server computing device; receiving at least one notification from the at least one server, based on the at least one sent location data element, wherein the at least one notification may include one or more position samples, each position sample representing a geographical position of a second client computing device at a specific timestamp; continuously analyzing position samples located between the current location of the first client computing device and a position sample corresponding to a latest timestamp; and producing a vulnerable vehicle awareness notification or two-wheeler awareness notification, based on the analysis.

The terms “vulnerable vehicle awareness notification” and “two-wheeler awareness notification” may be used interchangeably with the term “awareness notification”, for short.

According to some embodiments, analyzing the position samples may include counting the position samples located between the current location of the first client computing device and the position sample of the latest timestamp.

According to some embodiments, the at least one processor of the first client computing device may produce the awareness notification based on the counted position samples.

Additionally, or alternatively, if a number of counted position samples falls below a predefined threshold at a predefined rate, then the at least one processor may produce the awareness notification. Alternatively, if the number of counted position samples does not fall below the predefined threshold at the predefined rate, then the at least one processor may refrain from producing the awareness notification.

According to some embodiments, the at least one processor of the first client computing device may: analyze the position samples by counting the position samples located between the current location of the first client computing device and the position sample of the latest timestamp; receive a velocity data element, representing velocity of the first client computing device; and producing the awareness notification based on the counted position samples and the velocity data element.

According to some embodiments, the at least one processor of the first client computing device may produce at least one vehicle awareness signal, indicating proximity of a vehicle, based on the analysis of position samples; and transmit the vehicle awareness signal to a controller of an autonomous vehicle. The controller of the autonomous vehicle may, in turn, control at least one actuator, such as an actuator of a braking system, an actuator of a gas pedal or an actuator of a steering system, to conduct the autonomous vehicle.

Embodiments of the invention may include a method of producing an awareness notification by at least one processor of at least one server computing device.

Embodiments of the method may include receiving, from a first client computing device, a location data element, representing current geographical location of the first client computing device; repeatedly receiving, from one or more second client computing devices, a corresponding position sample, where the position sample represents a current geographical position of the relevant second client computing device, and is associated with a current timestamp.

According to some embodiments, the at least one processor of the at least one server device may, for at least one second client computing device of the one or more second client computing devices: select a subset of the corresponding position samples, based on the respective timestamps; identify a condition of geographical vicinity between the first client computing device, as represented by the location data element and the at least one second client computing device as represented by at least one position sample of the subset of position samples; and based on the identified condition, send the subset of position samples to the first client computing device. The first client computing device may, in turn, produce an awareness notification based on the subset of position samples.

According to some embodiments, the at least one processor of the at least one server device may select a subset of the corresponding position samples by selecting the latest position samples, based on the associated timestamps, up to a predefined number of position samples.

Additionally, or alternatively, the at least one processor of the at least one server device may determine, based on the timestamps of the selected subset of position samples and the location data element of the first client computing device, whether the first client computing device may be approaching, or nearing the relevant second client computing device. The at least one processor of the at least one server device may subsequently perform the identification of a condition of geographical vicinity based on the determination (e.g., if the first client computing device is indeed approaching, or nearing the relevant second client computing device).

According to some embodiments, the at least one processor of the at least one server device may determine, based on the timestamps of the selected subset of position samples and the location data element of the first client computing device, whether the first client computing device may be approaching or nearing the relevant second client computing device; and discard the selected subset of position samples, in relation to the first client computing device when the first client computing device may be determined as not approaching the relevant second client computing device.

Embodiments of the invention may include a system for producing an awareness notification. Embodiments of the system may include at least one server computing device and a plurality of client computing devices.

According to some embodiments, the at least one server computing device may be configured to: receive, from a first client computing device, a location data element, representing current geographical location of the first client computing device; repeatedly receive from at least one second client computing device, a corresponding position sample, representing a current geographical position of the at least one second client computing device, and associated with a current timestamp.

According to some embodiments, the at least one server computing device may, handle or serve one or more second client computing devices. For example, for one or more second client computing devices, the at least one server may: select a subset of the corresponding position samples, based on the associated timestamps; identify a condition of geographical vicinity between the geographical location of the first client computing device and the geographical position represented by at least one position sample of the subset of position samples; and based on the identified condition, send the subset of position samples to the first client computing device, Additionally, the first client computing device may be configured to produce an awareness notification based on the location data element and the subset of position samples.

According to some embodiments, the at least one server may include a plurality of servers, each configured to store position samples of second client computing devices as a quadtree data structure. Each cell of the quadtree data structure may correspond to: (a) a predetermined geographical region, and (b) a respective server.

Additionally, or alternatively, each server of the plurality of servers may be configured to store position samples of the second client computing devices according to the predetermined geographical region.

Additionally, or alternatively, each server of the plurality of servers may be configured to handle, or serve the at least one second client computing device according to the respective geographical region (e.g., currently residing within the relevant geographical region).

Embodiments of the invention may include a system for producing a vulnerable vehicle awareness notification. Embodiments of the system may include at least one first client computing device. The at least one first client computing device may in turn include a non-transitory memory device, wherein modules of instruction code are stored, and at least one processor associated with the memory device, and configured to execute the modules of instruction code.

Upon execution of said modules of instruction code, the at least one processor may be configured to send at least one location data element, representing current geographical location of the first client computing device to a server computing device; receive at least one notification from the server, based on the at least one sent location data element, wherein the at least one notification comprises one or more position samples, each position sample representing a geographical position of a second client computing device, associated with a vulnerable vehicle, at a specific timestamp; continuously analyze position samples located between the current location of the first client computing device and a position sample corresponding to a latest timestamp; and produce the awareness notification, based on said analysis.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for producing traffic vulnerable vehicle awareness notifications, according to some embodiments;

FIG. 2 is a block diagram depicting a system for producing vulnerable vehicle awareness notifications, according to some embodiments of the invention;

FIG. 3 is a schematic diagram depicting timestamped samples of positions of vehicles, according to some embodiments of the invention;

FIG. 4 is a block diagram depicting a system for producing vulnerable vehicle awareness notifications according to some embodiments of the invention;

FIG. 5 is a flow diagram depicting a method of producing a vulnerable vehicle awareness notification by at least one processor of a client computing device, according to some embodiments of the invention; and

FIG. 6 is a flow diagram depicting a method of producing a vulnerable vehicle awareness notification by at least one processor of a server computing device, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

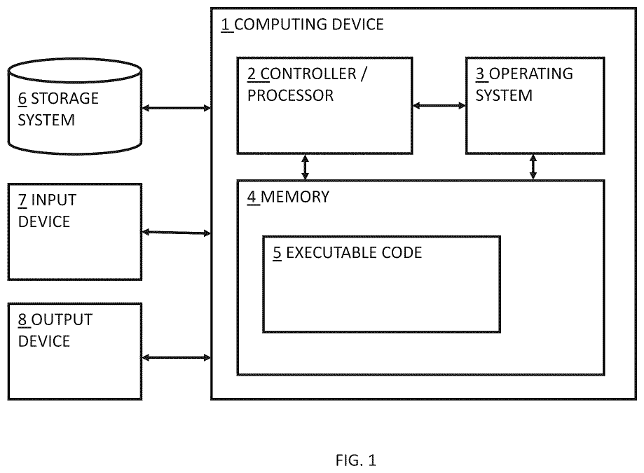

Reference is now made to FIG. 1, which is a block diagram depicting a computing device, which may be included within an embodiment of a system for producing vulnerable vehicle awareness notifications or two-wheeler awareness notifications (or “awareness notification”, for short), according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be, or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may produce awareness notifications as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data pertaining to location of one or more client computing devices may be stored in storage system 6 and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse, and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

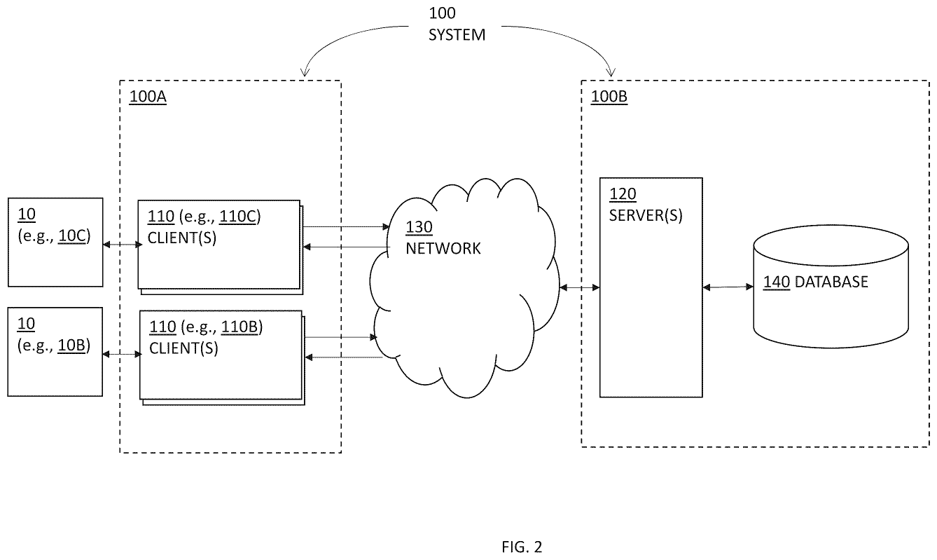

Reference is now made to FIG. 2, which is a block diagram depicting a system 100 for producing traffic awareness notifications, according to some embodiments of the invention. The term “awareness notification” may be used herein to indicate any type of warning or notification that may be produced or displayed by system 100, and may indicate vicinity of a vulnerable vehicle (e.g., a two-wheeler vehicle 10B, such as a bicycle).

For example, a vulnerable vehicle awareness notification may include displayed data (e.g., on output device 8, such as a computer screen) regarding a location of a vulnerable vehicle (e.g., bicycle) 10B in the vicinity (e.g., closer than a predetermined distance) of system 100.

It may be appreciated that the relevant vehicle 10B may be beyond a line of sight of system 100. For example, system 100 may be included in, or installed on a car, from which the location of vulnerable vehicle 10B is occluded. In some embodiments, when a distance between the location of system 100 and vehicle 10B falls below a predetermined threshold, the awareness notification may include a collision alert, warning a user of system 100 against an upcoming collision.

According to some embodiments of the invention, system 100 may be implemented as a software module, a hardware module, or any combination thereof. For example, system may be or may include a computing device such as element 1 of FIG. 1, and may be adapted to execute one or more modules of executable code (e.g., element 5 of FIG. 1) to produce awareness notifications, as further described herein.

As shown in FIG. 2, arrows may represent flow of one or more data elements to and from system 100 and/or among modules or elements of system 100. Some arrows have been omitted in FIG. 2 for the purpose of clarity.

According to some embodiments, and as shown in FIG. 2, system 100 may be, or may include a first portion, denoted in FIG. 2 as element 100B. Portion 100B may include one or more computing devices, such as one or more server devices 120. The one or more server devices 120 may be, or may include computing devices such as computing device 1 of FIG. 1, and may be configured to communicate, via a communication network 130 (e.g., a cellular network, the Internet, etc.) with one or more client computing devices. According to some embodiments, the one or more servers 120 may be cloud-based servers, facilitating automatic provisioning and discarding of cloud resources as the demand for computation resources increases or decreases.

Additionally, or alternatively, system 100 may include a second portion, denoted in FIG. 2 as element 100A. Portion 100A may include a combination, or a plurality of client computing devices 110 (e.g., 110B, 110C). The plurality of client devices 110 (e.g., 110B, 110C) may be, or may include computing devices such as computing device 1 of FIG. 1, and may be configured to communicate, via a communication network 130 with one or more server computing devices 120.

According to some embodiments, the plurality of client devices 110 may be associated with, included in, carried by, or installed on a respective plurality of vehicles or road-users. Additionally, or alternatively, the one or more client devices 110 may be configured to operate according to the type of the associated vehicle or road-user.

For example, the plurality client devices 110 may include at least one first client device 110B, associated with a vulnerable vehicle 10B, such as a two wheeler vehicle (e.g., bicycles, motorcycles, electric scooters, and the like). Such client devices 110 may be denoted herein as 100B (e.g., ‘B’ for “Bicycle”), and may also be referred to herein as “vulnerable clients” or “two-wheeler clients” 110B.

It may be appreciated that clients 110B may refer to other forms or types of vulnerable vehicles, such as skateboard and motorcycle riders. Moreover, a role of vulnerability may change according to context. For example, a car may be referred to as a vulnerable vehicle, in relation to a truck. Therefore, reference of clients 110B as corresponding to Two-wheeler riders should be regarded as a convenient, but non-limiting example.

Additionally, or alternatively, the plurality client devices 110 may include at least one second client device 110C, associated with a motor vehicle 10C, such as a car. Such client devices 110 may be denoted herein as 110C (‘C’ for “Car”), and may also be referred to herein as “car clients” 110C.

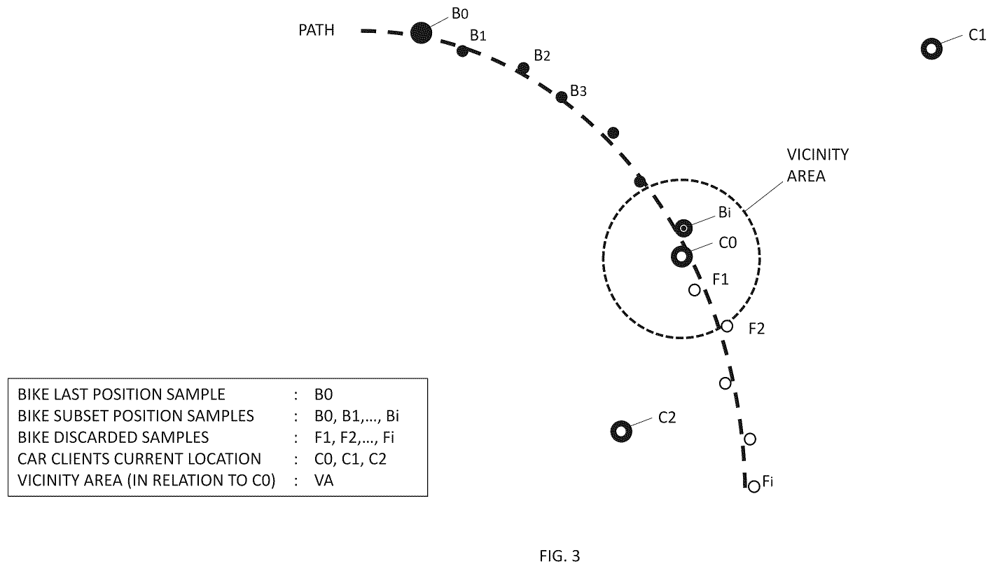

Reference is now made to FIG. 3, which is a schematic diagram depicting timestamped samples of positions of vehicles, according to some embodiments of the invention.

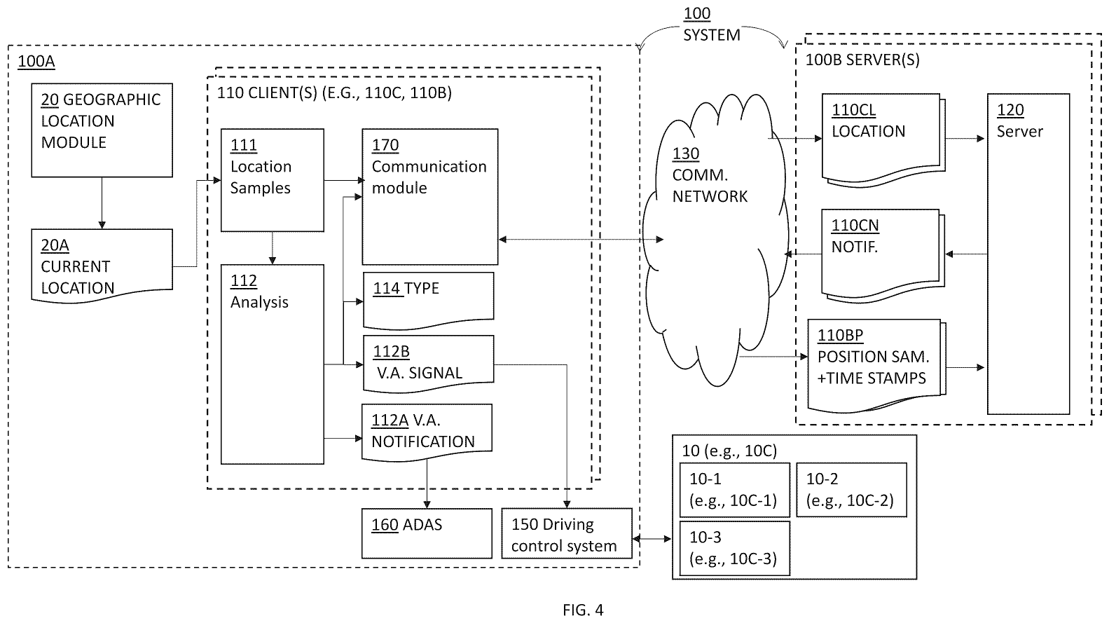

Reference is also made to FIG. 4, which is a block diagram depicting a system 100 for producing awareness notifications 112A and/or vehicle awareness signals 112B, according to some embodiments of the invention.

According to some embodiments, system 100 of FIG. 4 may be the same as system 100 of FIG. 2.

According to some embodiments, the one or more client computing devices 110 (e.g., 110B, 110C) may include, or may be communicatively associated with a geographic location module 20. Geographic location module 20 may be configured to obtain, or calculate a current geographic location 20A of the client computing device 110. The term “current” may be used in this sense to indicate a geographic location 20A in a specific time, sampled or calculated in real-time, or near real time. For example, geographic location module 20 may be geographic positioning system (GPS) module, adapted to calculate a current geographic location 20A of the client computing device 110 based on GPS satellite signals. In another example, geographic location module 20 may be adapted to receive RF transmission from a plurality of ground based emitters (e.g., cellular base stations), and perform triangulation of the received RF transmissions, to obtain current geographic location 20A.

According to some embodiments, at least one client computing device 110 (e.g., car client 110C) may include a location sample module 111 configured to sample the current geographic location 20A. Client computing device 110 may send sampled geographic location 20A as at least one location data element 110CL to at least one server computing device 120 via a communication module 170 (e.g., a cellular Modulator-Demodulator (MODEM), an NIC, and the like). The at least one location data element 110CL may represent the current geographical location of the client computing device 110 (e.g., 110C).

Additionally, or alternatively, one or more client computing devices 110 (e.g., two-wheeler client devices 110B) may each be associated with, or installed on a respective vulnerable vehicle such as a two-wheeler vehicle. The one or more client computing devices 110 be configured to sample 111 the current geographic location 20A. Client computing devices 110 (e.g., 110B) may then send at least one position sample data element 110BP representing timestamped samples of current geographical positions 20A of the or more client devices 110B (e.g., a location of an associated vulnerable vehicle such as a bicycle) to server computing device 120, via communication module 170.

The at least one server 120 may continuously (e.g., repeatedly over time) receive the at least one location data element 110CL from one or more client computing device (e.g., car client devices 110C). Additionally, or alternatively, the at least one server 120 may continuously (e.g., repeatedly over time) receive the position sample data element 110BP from the one or more client devices 110 (e.g., two-wheeler client 110B).

The terms “position” “location”, “position sample data element” and/or “location data element” may be used in this context to refer to a data element that may represent a geographical position, e.g., in the format of latitude and/or longitude coordinates, or any other appropriate coordinates of a respective client computing device.

The term “timestamp” or “timestamped” may be used herein to refer to metadata, that may indicate a label of current time e.g., in a Coordinated Universal Time (UTC) format, or another appropriate format.

In the example of FIG. 3, points B0, . . . , Bi and F1, . . . , Fi may be timestamped samples of geographical positions of a vehicle (e.g., the two-wheeler vehicle) at respective points in time, as represented by respective position sample data elements 110BP.

According to some embodiments, the at least one server 120 may be configured to handle or serve at least one of the one or more client computing devices 110B (e.g., two-wheeler clients). For example, for at least one client computing device 110B, server 120 may continuously (e.g., repeatedly over time) select a subset (e.g., B0, . . . , Bi) of the received position sample data elements 110BP (e.g., B0, . . . , Bi and F1, . . . , Fi), based on the associated timestamps.

According to some embodiments, the at least one server 120 may maintain a predefined number of position sample data elements for each tracked two-wheeler client device 110B, by discarding old samples (denoted F1, . . . , Fi), as new samples (e.g., B0) are received. In other words, the at least one server 120 may keep, or maintain the subset of samples (e.g., B0, . . . , Bi) in a memory device (e.g., memory 4 of FIG. 1) or storage (e.g., storage 6 of FIG. 1) as the vehicle (e.g., the two-wheeler vehicle) travels along a path, as depicted in FIG. 3.

As known in the art, the term “Quadtree” may be used herein to indicate a tree data structure, in which each internal node or cell may have exactly four children. Quadtrees are commonly used to partition a two-dimensional space by recursively subdividing it into four quadrants or regions, where each leaf cell may represent a unit of spatial information of interest.

In some embodiments, the at least one server 120 may keep, or maintain the subset of samples (e.g., B0, . . . , Bi) on a geo-spatial database, as a geo-spatial data structure, such as a Quadtree data structure.

For example, the at least one server 120 may include a plurality of servers, configured to store location data elements 110CL (e.g., of client computing devices 110B) and/or position sample data elements 110BP (e.g., of client computing devices 110B) as a quadtree data structure. Each cell of the quadtree data structure may correspond to a predetermined geographical region (e.g., a quadrature portion of a map). Additionally, each cell of the quadtree data structure may correspond to, associated with, or served by a respective server of the plurality of servers.

According to some embodiments, each server of the plurality of servers may be configured to store position sample data elements 110BP and/or location data elements 110CL according to the predetermined geographical region.

Additionally, or alternatively, each server 120 of the plurality of servers may be configured to handle or serve client computing devices 110B/110C according to the respective geographical region, e.g., serve client computing devices 110B/110C that currently reside within the corresponding geographical region.

It may be appreciated that such geographically-oriented storage and processing of client 110 data (e.g., location data elements 110CL and/or position sample data elements 110BP), where each server may handle or serve only client devices that currently reside within a respective, local geographic cell, may prove efficient in terms of analysis and retrieval of local data.

Additionally, as known in the art, Quadtree data structures may be configured to divide the underlying geographic area in a dynamic manner, to accommodate changes in a workload. In other words, the one or more servers 120 may be configured to dynamically alter the location and/or size of the predetermined geographical region, according to the number of client devices 110B/110C that reside in these geographical regions.

For example, geographical regions that are congested by a relatively large number of vehicles (e.g., many client devices 110B/110C) may be dynamically divided by a relatively large number of Quadtree cells, and a corresponding large number of servers 120. In a complementary manner, geographical regions that are sparsely populated (e.g., a small number of client devices 110B/110C) may be aggregated and served by a relatively small number of Quadtree cells, and a corresponding small number of servers 120.

The timestamped samples maintained by server 120 are denoted in FIG. 3 as points ‘B’. In this example: (a) point B0 represents the last (e.g., the most recent) timestamped sample of the client 110B (e.g., the two-wheeler vehicle) position, maintained by server 120; (b) point Bi represents the first (e.g., the earliest) timestamped position sample of the client 110B (e.g., the two-wheeler vehicle) position, maintained by server 120; and (c) points B0, . . . , Bi represent the complete subset of timestamped position samples, received as position sample data elements 110BP, and maintained by server 120 (e.g., in a database or storage device 6 of FIG. 1).

It may be appreciated that points B0, . . . , Bi may be regarded as a limited “tail” of two-wheeler client device 110B, in a sense that the timestamped position samples may follow the position of two-wheeler client device 110B as it progresses along a path, to a limited distance (or number of samples) behind the latest sampled position (e.g., B0).

Additionally, or alternatively, server 120 may be configured to receive from one or more (e.g., a plurality) of client devices 110 (e.g., car client devices 110C), one or more location data elements 110CL. Location data elements 110CL may represent a current geographical location of the respective client computing devices 110C. For example, the one or more location data elements 110CL may be timestamped samples of geographical locations of respective, associated motor vehicles (e.g., associated cars). These timestamped location samples are denoted as elements ‘C’ (e.g., C0, C1, C2) in FIG. 3.

As elaborated herein, server 120 may identify at least one client 110C (e.g., client 110C associated with a car) as relevant to the path of a client 110B (e.g., two-wheeler client 110B).

For example, server 120 may identify a condition of geographical vicinity between the geographical location sample (e.g., C0) of at least one client computing device 110C (e.g., car client 110C) and the geographical position of at least one client 110B (e.g., two-wheeler client 110B), represented by at least one position sample (e.g., Bi) of the subset of position samples (e.g., B0, . . . , Bi).

According to some embodiments, server 120 may analyze the received position sample data elements 110BP (e.g., B0, . . . , Bi and F1, . . . , Fi) in relation to the geographical location sample (e.g., C0), so as to select the subset of position sample data elements 110BP (e.g., B0, . . . , Bi), and subsequently identify the condition of geographical vicinity based on this analysis.

For example, server 120 may analyze a subset of position sample data elements 110BP (e.g., B0, . . . , Bi) to determine, based on the timestamps of the selected subset of position samples, and the location data element (e.g., geographical location sample, C0) of the car client computing device 110C, whether the car client computing device 110C is approaching the relevant two-wheeler client computing device 110B. In this context, the term “approaching” may be used to indicate a process of increasing relative vicinity, regardless of individual movement of client 110C and/or client 110B.

For example, if the timestamps of position sample data elements 110BP indicate an increasingly recent time, then server 120 may determine that client 110C is approaching the relevant client 110B. In a complementary example, if the timestamps of position sample data elements 110BP indicate an increasingly earlier time, then server 120 may determine that client 110C is not approaching the relevant client 110B.

Based on this determination, server 120 may perform the process of identification of the condition of geographical vicinity between the relevant client 110C and one or more clients 110B. In other words, if server 120 determines that client computing device 110C is nearing-in, or approaching client computing device 110B, then server 120 may proceed to identification of the condition of geographical vicinity between the relevant client 110C and one or more clients 110B, and optionally send a Notification 110CN to the relevant client 110C.

Additionally, or alternatively, if server 120 determines that client computing device 110C is not nearing-in, or approaching client computing device 110B, then server 120 may discard the selected subset of position samples 110BP (e.g., B0, . . . , Bi), at least in relation in relation to a specific client device 110C.

In the example of FIG. 3, server 120 may determine that a timestamped position sample of client 110B (e.g., Bi) is in close vicinity (denoted “vicinity area” in FIG. 3) to a current geographical location sample of a car client 110C (denoted C0). In other words, and pertaining to the “tail” analogy, server 120 may identify a condition in which a car client device 110C is “stepping on a tail” of a two-wheeler client device 110B, at position Bi.

According to some embodiments, following this identified condition, server 120 may communicate via network 130 a notification 110CN to the at least one identified client 110C (e.g., C0). In some embodiments, server 120 may transmit notification 110CN only to the relevant, identified client 110C (e.g., C0). In other words, identified client 110C (e.g., C0) may receive at least one notification 110CN from server 120 based on the at least one sent location data element 110CL.

Notification 110CN may include just enough information that may be required by the at least on identified client device 110C to assess a risk of collision with the relevant two-wheeler client device 110B. In some embodiments, notification 110CN may include one or more position samples (e.g., B0, . . . , Bi), where each position sample represents a geographical position of a relevant two-wheeler client device 110B at a specific timestamp.

For example, server 120 may send a notification 110CN to car client 110C based on the identification of a condition in which the geographical location sample (e.g., C0) of client 110C (e.g., a car client) and the geographical position sample (e.g., Bi) of client 110B are in close geographical vicinity (e.g., car client 110C is “stepping on the tail” of two-wheeler client 110B). Notification 110CN may, for example include the selected subset of maintained position samples (e.g., B0, . . . , Bi) and their corresponding timestamps.

Car client 110C may continuously (e.g., repeatedly, over time) analyze the location data element 20A (e.g., representing current location sample C0) and the received subset of maintained position samples (e.g., B0, . . . , Bi) to provide an awareness notification, and/or determine a risk or probability of collision, as elaborated herein. Car client 110C may subsequently produce an awareness notification 112A and/or vehicle awareness signal 112B based on this analysis.

Additionally, or alternatively, car client device 110C may continuously analyze position samples located between the current location 20A (denoted C0 in FIG. 3) of the client computing device and a position sample (denoted B0 in FIG. 3) corresponding to the latest timestamp. Car client device 110C may subsequently produce an awareness notification 112A and/or vehicle awareness signal 112B based on this analysis, as elaborated herein.

As elaborated herein, embodiments of the invention may include a practical application for providing an awareness notification (e.g., a collision alert) and/or a vehicle awareness signal, for controlling or conducting an autonomous vehicle. Moreover, embodiments of the invention may include a plurality of improvements over currently available systems and methods of assisted driving and collision avoidance.

For example, embodiments of the invention may produce awareness notifications based on independently obtained geographic location information, and may not be dependent upon a line of sight between vehicles.

Additionally, As elaborated herein, system 100 may perform the analysis and decide on whether there is a need to produce an awareness notification 112A by the car client computing device 110C. This is in contrast to currently available systems in which such decisions are performed on a central server computing device.

Thus, embodiments of system 100 may include an improvement in technology in relation to currently available systems for awareness notifications by (a) reducing computational and communicational load of the server, (b) reducing need for server computing resources (e.g., memory, processing cycles, maintenance etc.), and (c) reducing the risk of system crash or malfunction.

Additionally, embodiments of system 100 may include an improvement in technology in relation to currently available systems for awareness notifications by providing a notification or alert to a driver or a self-driving system, independent of the operative condition of a central server, or failure of communication. In other words, a car client computing device 110C may produce an awareness notification 112A and/or vehicle awareness signal 112B independent of communication between server 120 and the one or more client computing devices 110.

Additionally, embodiments of system 100 may include an improvement in technology in relation to currently available systems for awareness notifications by utilizing the calculation power of all the car client computing devices 110C. Consequently, embodiments of system 100 may reduce a central server's computational load and/or communicational load. This, in turn, improve a yield of collision risk analysis, because each car client device 110C may not need to analyze a collision risk for other cars, but only for itself.

Moreover, such local analysis of collision risk by client computing devices 110C may produce an alert notification substantially immediately (e.g., independent of a communication network). Such implementation may prove particularly beneficial for systems of autonomous driving, where real-time control of a vehicle is required.

According to some embodiments, system 100 may be included in, or may be associated with an Advanced driver-assistance system (ADAS) 160. In such embodiments, awareness notifications 112A may include, for example alerts or warnings, configured to be presented to a user or driver on a user interface (UI), such as output device 8 of FIG. 1. Such a UI may, for example, include a monitor or screen associated with, or included in client device 110 (e.g., car client computing device 110C) or ADAS 160.

Additionally, or alternatively, system 100 may be included in, or may be associated with an autonomous driving system or driving control system 150. As known in the art, an autonomous driving system 150 may be communicatively connected with one or more controllers (e.g., controller 10C-1 of FIG. 4) and/or actuators (e.g., actuator 10C-2 of FIG. 4) of an autonomous vehicle e.g., 10C. Autonomous driving system 150 may thus conduct autonomous vehicle 10C via the one or more controllers 10C-1 and/or actuators 10C-2, e.g., by steering the autonomous vehicle 10C in a required direction (e.g., by a steering wheel), determining a speed of the autonomous vehicle 10C (e.g., by controlling a gas pedal and/or a brake pedal, and the like).

In such embodiments, analysis module 112 may produce at least one vehicle awareness signal 112B, which may indicate proximity of a vehicle 10B. For example, vehicle awareness signal 112B may include a warning or alert against an imminent collision. Car client device 110C may transmit vehicle awareness signal 112B to driving control system 150. Driving control system 150 may then analyze vehicle awareness signal 112B (e.g., evaluate a severity of the alert), and communicate a command to at least one controller 10C-1 and/or actuator 10C-2 based on the analysis. Such a command may be, for example a command to operate an actuator 10C-2 of the autonomous vehicle's 10C braking system, a command to operate an actuator 10C-2 of the autonomous vehicle's 10C gas pedal and/or a command to operate an actuator 10C-2 of the autonomous vehicle's 10C steering system, to conduct the autonomous vehicle 10C (e.g., to avoid an upcoming collision).

As elaborated herein, car client 110C may continuously analyze the location data element 20A and/or the subset of maintained position samples (e.g., B0, . . . , Bi) to determine a risk or probability of collision, and produce a respective awareness notification 112A and/or vehicle awareness signal 112B.

For example, car client 110C may count the position samples (e.g., B0, . . . , Bi) located between the current location of car client computing device 110C (denoted C0) and the position sample of the latest maintained timestamp (denoted B0 in FIG. 3), representing the latest sampled position of the two-wheeler client device 110B. Car client 110C may then produce the awareness notification 112A and/or vehicle awareness signal 112B based on the counted position samples. Pertaining to the example of FIG. 3, if the number of maintained position samples (e.g., B0, . . . , Bi, in this example-7) is below a predetermined threshold number (e.g., 10), then car client 110C may produce an awareness notification 112A and/or vehicle awareness signal 112B that includes the number and/or geographical positions of position samples B0, . . . , Bi.

Additionally, or alternatively, car client 110C may produce awareness notification 112A and/or vehicle awareness signal 112B based on the counted position samples and/or on the relative speed between client device 110C and client device 110B (e.g., the rate at which a motor vehicle is “closing in” on a two-wheeler vehicle).

For example, if (a) a number (in this example—7) of counted position samples (B0, . . . , Bi) between the current location C0 of car client computing device 110C and the position sample of the latest maintained timestamp (denoted B0) falls below a predefined threshold (e.g., 10), and (b) this number decreases beyond a predefined rate (e.g., more than one sample point per second), then car client 110C may produce awareness notification 112A and/or vehicle awareness signal 112B. In a complementary manner, if the number of counted position samples (B0, . . . , Bi) does not fall below the predefined threshold (e.g., 10), or does not do so at the predefined rate, then car client 110C may refrain from producing awareness notification 112A and/or vehicle awareness signal 112B.

Additionally, or alternatively, car client 110C may produce awareness notification 112A and/or vehicle awareness signal 112B based on the counted position samples and/or actual velocity of the vehicle 10C associated with car client 110C.

For example, car client 110C may receive from at least one sensor 10C-3 of vehicle 10C at least one velocity data element, representing velocity of car client computing device 110C. For example, sensor 10C-3 may be a speedometer, and velocity data element may be a reading of velocity sensor 10C-3. Additionally, or alternatively, car client 110C may receive current location data 20A pertaining to two separate points in time from geographical location module 20, and may calculate a velocity of vehicle 10C from location data 20A.

Car client 110C may the produce awareness notification 112A and/or vehicle awareness signal 112B based on the counted position samples and/or the velocity data element.

For example, if: (a) a number of counted position samples (B0, . . . , Bi, in the example of FIG. 3, this number is 6) between the current location C0 of car client computing device 110C and the position sample of the latest maintained timestamp (denoted B0) falls below a predefined threshold (e.g., 8), and (b) the velocity data element indicates that the velocity of vehicle 10C of car client computing device 110C exceeds a predefined threshold, then car client 110C may produce awareness notification 112A and/or vehicle awareness signal 112B.

In a complementary manner, if conditions (a) or (b) are not fulfilled, then car client 110C may refrain from producing awareness notification 112A and/or vehicle awareness signal 112B.

As elaborated herein, system 100 may include one or more (e.g., a plurality) of servers 100B, which may continuously obtain and manage, in a distributed manner (e.g., where specific servers 100B are appointed to specific geographical regions), location data pertaining to a plurality of client computing devices 110. Servers 100B may receive, from at least one (e.g., a plurality) of car client computing devices 110C one or more location data elements 110CL representing current geographical locations of car client computing devices 110C, associated with respective timestamps. Servers 100B may also repeatedly receive from at least one (e.g., a plurality) of vulnerable vehicle (e.g., bicycle) client computing devices 110B, one or more corresponding position samples 110BP, representing current geographical positions of respective at least one bicycle client computing device 110B, also associated with respective timestamps.

As elaborated herein (e.g., in relation to FIG. 3), server(s) 100B may select or maintain a relevant subset position samples (e.g., B0, . . . , Bi), that based, e.g., on their respective timestamps.

Client device(s) 110B and/or client device(s) 110C may be configured to produce an awareness notification based on the location data element(s) 110CL and the subset of position samples 110BP.

For example, a server 100B may communicate the subset of position samples 110BP to a car client 110C, as a “push” message, or as a response to a query initiated by client 110C. The subset of position samples 110BP may include, or represent historical, timestamped positions of at least one client 110B of a vulnerable vehicle (e.g., bicycle), in a geographical proximity to the relevant car client device 110C.

As elaborated herein (e.g., FIG. 3) car client device 110C may analyze the subset of position samples 110BP vis-à-vis the one or more location data elements, and/or current location 20A (e.g., obtained from geographic location module 20), to determine a condition in which the car client device 110C is closing-in on historical positions of the bicycle client computing device 110B (as represented by the subset of position samples 110BP). Car client device 110C may consequently produce the awareness notification 112A according to the determined condition, e.g., when the car is closing-in on the bicycle at a rate that exceeds a predefined threshold.

Additionally, or alternatively, client 110B (e.g., installed on a vulnerable vehicle such as a bicycle) may obtain the subset of position samples 110BP and/or the one or more location data elements 110CL from server(s) 100B. Client 110B may do so, for example by a server “push” message, or as a response to a query initiated by client 110B.

In a similar manner to that described above, client 110B may analyze the subset of position samples, vis-à-vis the one or more location data elements, to determine a condition in which the location 110CL of client 110C (e.g., car) is closing-in on historical positions of client 110B (the vulnerable vehicle) as represented by the subset of position samples 110BP. Client 110B may consequently produce the awareness notification 112A according to the determined condition, e.g., when the car is closing-in on the bicycle at a rate that exceeds a predefined threshold.

Additionally, or alternatively, client 110B may apply additional logic to produce awareness notification 112A. For example, client 110B may employ time-based cool-down on awareness notifications 112A, to avoid an overwhelming number or rate of notifications, and subsequent warning fatigue.

In another example, client 110B may introduce additional criteria for warning: For example, client 110B may analyze timestamped location data elements 110CL of a car to identify a vehicle that is exceeding a speed threshold, or exhibiting erratic behaviour such as zigzagging.

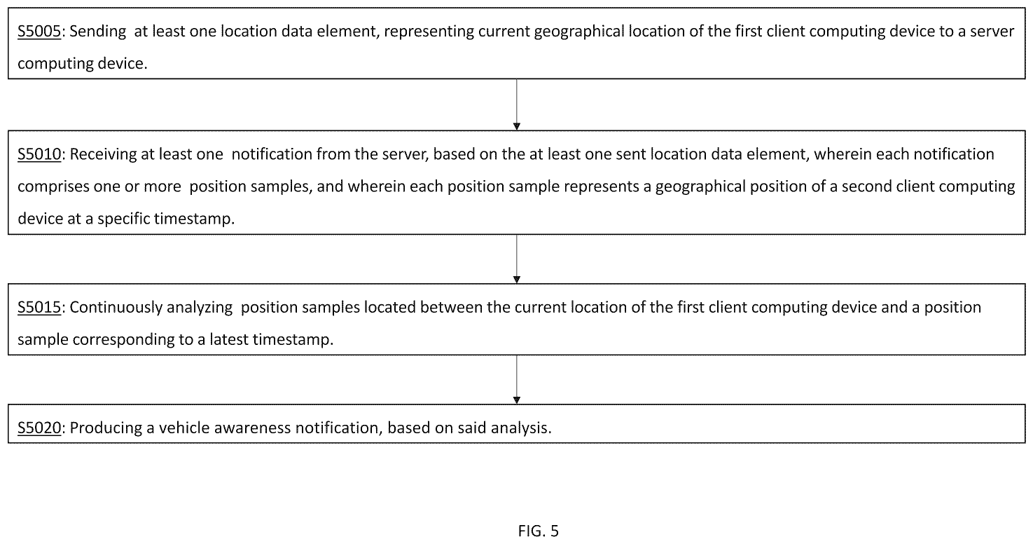

FIG. 5 is a flow diagram depicting a method of producing an awareness notification by at least one processor of a client computing device, according to some embodiments of the invention.

As shown in step S5005, at least one processor (e.g., element 2 of FIG. 1) of a first client computing device (e.g., element 110C of FIG. 2) may repeatedly send at least one location data element, representing a current geographical location of the first client computing device 110C to a server computing device (e.g., server 120 of FIG. 2).

As shown in step S5010, the at least one processor 2 of first client computing device 110C may receive at least one notification (e.g., Notification 110CN of FIG. 4) from server 120, based on the at least one sent location data element. The at least one notification may include one or more position sample data elements (e.g., position samples 110BP of FIG. 4, and/or elements B0, . . . , Bi and F1, . . . , Fi of FIG. 3). Each position sample 110BP may represent a geographical position of a second client computing device (e.g., element 110B of FIG. 2) at a specific timestamp.

As shown in step S5015, the at least one processor 2 of first client computing device 110C may continuously (e.g., repeatedly, over time) analyze position samples located between the current location of the first client computing device and a position sample corresponding to a latest timestamp, as elaborated herein (e.g., in relation to FIG. 3 and/or FIG. 4).

As shown in step S5020, the at least one processor 2 of first client computing device 110C may produce an awareness notification (e.g., element 112A of FIG. 4), based on said analysis, to be presented to a driver (e.g., as part of an ADAS system, as elaborated herein). Additionally, or alternatively, the at least one processor 2 of first client computing device 110C may produce a vehicle awareness signal (e.g., element 112B of FIG. 4), based on said analysis, to control an autonomous vehicle 10C-1.

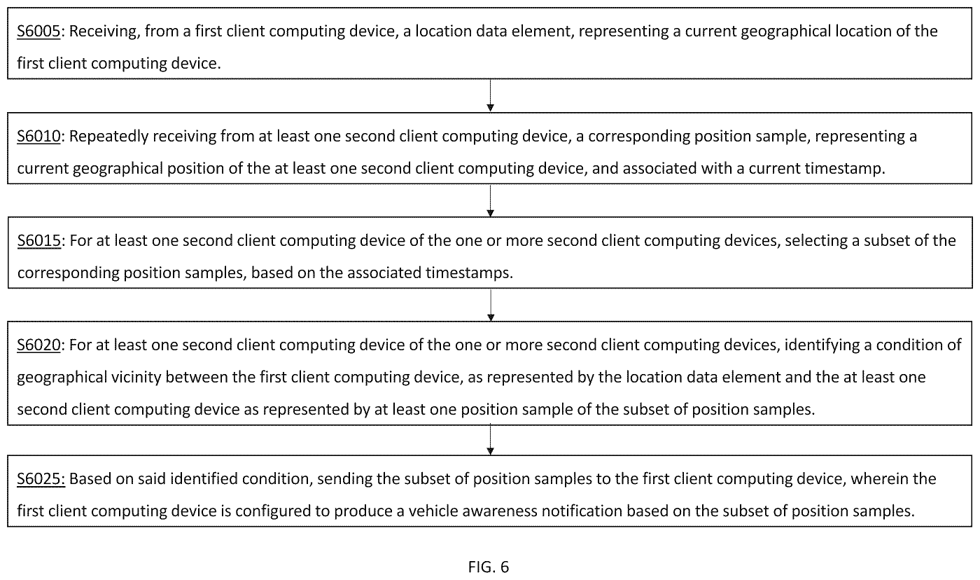

FIG. 6 is a flow diagram depicting a method of producing an awareness notification by at least one processor of a server computing device, according to some embodiments of the invention.

As shown in step S6005, at least one processor (e.g., element 2 of FIG. 1) of a server computing device (e.g., element 120 of FIG. 2) may receive, from a first client computing device (e.g., element 110C of FIG. 2) a location data element (e.g., element 110CL of FIG. 4), representing current geographical location of the first client computing device 110C.

As shown in step S6010, the at least one processor 2 of server computing device 120 may repeatedly receive, from one or more second client computing devices (e.g., element 110B of FIG. 2), a corresponding position sample data element (e.g., element 110BP of FIG. 4). Position sample data element may represent a current geographical position of the relevant second client computing device 110B, and may be associated with, or include a current timestamp.

As shown in step S6015, for at least one second client computing device of the one or more second client computing devices, the at least one processor 2 of server computing device 120 may select a subset of the corresponding position samples, based on the position sample data elements' respective timestamps.

As shown in step S6020, for at least one second client computing device of the one or more second client computing devices, the at least one processor 2 of server computing device 120 may identify a condition of geographical vicinity between the first client computing device (e.g., as represented by the location data element 110CL) and the at least one second client computing device (e.g., as represented by at least one position sample data element 110BP of the subset of position samples).

As shown in step S6025, for at least one second client computing device of the one or more second client computing devices, and based on the identified condition of vicinity, the at least one processor 2 of server computing device 120 may send the subset of position samples to the first client computing device.

As elaborated herein, the first client computing device 110C may be configured to produce an awareness notification 112A and/or a vehicle awareness signal 112B based on the subset of position samples.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of producing a vulnerable vehicle awareness notification by at least one processor of a first client computing device, the method comprising:
sending at least one location data element, representing current geographical location of the first client computing device to a server computing device;
receiving at least one notification from the server, based on the at least one sent location data element, wherein the at least one notification comprises one or more position samples, each position sample representing a geographical position of a second client computing device, associated with a vulnerable vehicle, at a specific timestamp;
continuously analyzing position samples located between the current location of the first client computing device and a position sample corresponding to a latest timestamp; and
producing the awareness notification, based on said analysis.

2. The method of claim 1, wherein analyzing the position samples comprises counting the position samples located between the current location of the first client computing device and the position sample of the latest timestamp, and wherein the method further comprises producing the awareness notification based on the counted position samples.

3. The method of claim 2, wherein:
if a number of counted position samples falls below a predefined threshold at a predefined rate, then producing the awareness notification; and
if the number of counted position samples does not fall below the predefined threshold at the predefined rate, then refraining from producing the awareness notification.

4. The method according to claim 1, wherein analyzing the position samples comprises counting the position samples located between the current location of the first client computing device and the position sample of the latest timestamp, and wherein the method further comprises:
receiving a velocity data element, representing velocity of the first client computing device; and
producing the awareness notification based on the counted position samples and the velocity data element.

5. The method of claim 1, further comprising:
producing at least one vehicle awareness signal, indicating proximity of a vehicle, based on the analysis of position samples; and
transmitting said vehicle awareness signal to a controller of an autonomous vehicle, wherein said controller is configured to control at least one actuator, selected from an actuator of a braking system, an actuator of a gas pedal and an actuator of a steering system, to conduct the autonomous vehicle.

6. A method of producing a vulnerable vehicle awareness notification by at least one processor of at least one server computing device, the method comprising:
receiving, from a first client computing device, a location data element, representing current geographical location of the first client computing device;
repeatedly receiving, from one or more second client computing devices, each associated with a respective vulnerable vehicle, a corresponding position sample, wherein said position sample represents a current geographical position of the relevant second client computing device, and is associated with a current timestamp; and
serving at least one second client computing device of the one or more second client computing devices by:
selecting a subset of position samples corresponding to the at least one second client computing device;
identifying a condition of geographical vicinity between the first client computing device, as represented by the location data element and the at least one second client computing device as represented by at least one position sample of the subset of position samples; and
based on said identified condition, sending the subset of position samples to the first client computing device, wherein the first client computing device is configured to produce the awareness notification based on the subset of position samples.

7. The method of claim 6, wherein selecting a subset of position samples comprises selecting the latest position samples, based on the associated timestamps, up to a predefined number of position samples.

8. The method of claim 7, wherein selecting a subset of the corresponding position samples further comprises:
determining, based on the timestamps of the selected subset of position samples and the location data element of the first client computing device, whether the first client computing device is approaching the relevant second client computing device; and
performing said identification of a condition of geographical vicinity based on said determination.

9. The method of claim 7, wherein selecting a subset of the corresponding position samples further comprises:
determining, based on the timestamps of the selected subset of position samples and the location data element of the first client computing device, whether the first client computing device is approaching the relevant second client computing device; and
discarding the selected subset of position samples, in relation to the first client computing device when the first client computing device is determined as not approaching the relevant second client computing device.

10. The method of claim 6, wherein the first client computing device is configured to:
send the at least one location data element to the at least one server computing device;
receive at least one notification from the at least one server, based on the at least one sent location data element, wherein the at least one notification comprises one or more position samples, each position sample representing a geographical position of a second client computing device at a specific timestamp;
continuously analyze position samples located between the current location of the first client computing device and a position sample corresponding to a latest timestamp; and
producing the awareness notification, based on said analysis.

11. The method of claim 10, wherein the first client computing device is configured to:
analyze the position samples by counting the position samples located between the current location of the first client computing device and the position sample of the latest timestamp; and
produce the awareness notification based on the counted position samples.

12. The method of claim 11, wherein the first client computing device is configured to:
if a number of counted position samples falls below a predefined threshold at a predefined rate, then produce the awareness notification; and
if the number of counted position samples does not fall below the predefined threshold at the predefined rate, then refrain from producing the awareness notification.

13. The method of claim 10, wherein the first client computing device is configured to:
analyze the position samples by counting the position samples located between the current location of the first client computing device and the position sample of the latest timestamp;
receive a velocity data element, representing velocity of the first client computing device; and
produce the awareness notification based on the counted position samples and the velocity data element.

14. The method of claim 10, wherein the first client computing device is configured to:
produce at least one vehicle awareness signal, indicating proximity of a vehicle, based on the analysis of position samples; and
transmit said vehicle awareness signal to a controller of an autonomous vehicle, wherein said controller is configured to control at least one actuator, selected from an actuator of a braking system, an actuator of a gas pedal and an actuator of a steering system, to conduct the autonomous vehicle.

15. The method of claim 6, wherein the at least one server comprises a plurality of servers, configured to store position samples of second client computing devices as a quadtree data structure, wherein each cell of the quadtree data structure corresponds to: (a) a predetermined geographical region, and (b) a respective server.

16. The method of claim 15, wherein each server of the plurality of servers is configured to store position samples of second client computing devices according to the predetermined geographical region.

17. The method of claim 15, wherein each server of the plurality of servers is configured to serve the at least one second client computing device according to the respective geographical region.

18. A system for producing a vulnerable vehicle awareness notification, the system comprising: at least one server computing device and a plurality of client computing devices, wherein the at least one server is configured to:
receive, from a first client computing device, one or more location data elements, representing current geographical locations of the first client computing device, wherein the location data elements are associated with respective timestamps;
repeatedly receive from at least one second client computing devices, one or more corresponding position samples, representing a current geographical position of the at least one second client computing device, wherein the position samples are associated with respective timestamps; and
selecting a subset of the corresponding position samples, based on the associated timestamps,
and wherein at least one of the first client device and second client devices are configured to produce the awareness notification based on the location data element and the subset of position samples.

19. The system of claim 18, wherein the first client computing device is installed on a car, and is configured to:
obtain the subset of position samples from the at least one server;
analyze the subset of position samples, vis-à-vis the one or more location data elements, to determine a condition in which the car is closing-in on historical positions of the second client computing device, as represented by the subset of position samples; and
produce the awareness notification according to said determined condition.

20. The system of claim 18, wherein the second client computing device is installed on a vulnerable vehicle, and is configured to:
obtain the subset of position samples from the at least one server;
obtain one or more location data elements from the at least one server;
analyze the subset of position samples, vis-à-vis the one or more location data elements, to determine a condition in which the location of the first client computing device is closing-in on historical positions of the vulnerable vehicle, as represented by the subset of position samples; and
produce the awareness notification according to said determined condition.

21.-25. (canceled)
